(19) United States
(12) Patent Application Publication
(10) Pub. No.: US 2010/0140896 A1
(43) Pub. Date: Jun. 10, 2010

(54) COMBINATION FENDER-SEAT COVER

(76) Inventor: Patricia Ellen McHale, Atherstone, CA (US)

Correspondence Address: WHITE-WELKER & WELKER, LLC, P.O. BOX 199, CLEAR SPRING, MD, 21722-0199, US

(21) Appl. No.: 12/633,931

(22) Filed: Dec. 9, 2009

Related U.S. Application Data
(60) Provisional application No. 61/201,409, filed on Dec. 9, 2008.

(51) Int. Cl. B62D 25/18

(52) U.S. Cl. 280/152.3

(57) ABSTRACT

A combination fender-seat cover for a dual-wheeled vehicle composed principally of a mount device, one or more cantilevered arms, and a convertible fender-seat cover device. Upon its attachment to a vehicle, the combination fender-seat cover is designed so that it has two primary operating positions: seat cover position and fender position. The invention's purpose is to protect the vehicle's driver and seat from inclement weather conditions. The method of position change from a first seat cover position to a second fender position or vice-versa is accomplished by a pivot or rotation, but can also be achieved by removal then reattachment, flexion, or translation. The combination fender-seat cover can have fixed or variable final and intermediate position options while converting from a first fender position to a second seat covering position. These position options can be achieved through various means such as pinning, snapping, bolting, and clamping into place.

### CROSS REFERENCE TO RELATED APPLICATIONS

This application claims priority from U.S. Provisional Patent Application Ser. No. 61/201,409, entitled “COMBINATION BICYCLE FENDER-SEAT COVER”, filed on 9 Dec. 2008. The benefit under 35 USC §119(e) of the United States provisional application is hereby claimed, and the aforementioned application is hereby incorporated herein by reference.

### FEDERALLY SPONSORED RESEARCH

Not Applicable

### SEQUENCE LISTING OR PROGRAM

Not Applicable

### TECHNICAL FIELD OF THE INVENTION

The present invention relates generally to a bicycle or motorcycle accessory. More specifically, the present invention relates to a bicycle or motorcycle attachment that can serve as a back protector or as a seat cover, when moved to various positions.

### BACKGROUND OF THE INVENTION

There has been a dramatic increase in the number of bicycles and motorcycles that are in use in North America. Also, the technology relating to a bicycle or motorcycle has developed considerably during the same time. Nowadays, there are many different types of bicycles and motorcycles available, such as high performance racing bicycles and motorcycles, mountain bicycles and motorcycles, and recreation bicycles and motorcycles. Many of the bicycles and motorcycles in use today do not have fenders or have minimal fender areas. Thus, when a bicycle or motorcycle travels through mud or a puddle, the rider of the bicycle or motorcycle becomes wet or sprayed from the mud being flung off the wheels. Also, if a bicycle or motorcycle is left outdoors, the seat of the bicycle or motorcycle can become wet from precipitation or damaged by UV rays. Many bicycles and motorcycles are so streamlined and reduced to the bare essentials, that there is no facility for carrying a load on the bicycle or motorcycle.

Many patents exist which describe fenders or seat covers that transform or translate into different operating positions. For example, U.S. Pat. No. 5,562,296 teaches a bicycle fender comprising a resilient plastic elongate substrate that is deformable between an operating configuration and a rolled storage configuration. Although a number of patents disclose various designs of bicycle attachments, there are no viable attachments available on the market today that protect the rider from spray from the rear wheels, and protect the seat cover when the bicycle or motorcycle is not in use.

### SUMMARY OF THE INVENTION

The present invention is a combination fender-seat cover for a dual-wheeled vehicle composed principally of a mount device, a cantilevered arm, and a convertible fender-seat cover device. Upon its attachment to a vehicle, the combination fender seat-cover is designed so that it has two primary operating positions: the seat cover position and the fender cover position. The invention's purpose is to protect the vehicle's driver and seat from inclement weather conditions.

The preferred method of position change from a first position to a second position or vice-versa is accomplished by a pivot or rotation, but can also be achieved by removal then reattachment. The fender-seat cover can have fixed or variable final and intermediate position options while converting from a first fender position to a second seat covering position. These position options can be achieved through various means such as pinning, snapping, bolting, and clamping into place.

The fender-seat cover is curved; however it can be straight and it can have longitudinal ribs for additional structural support. The fender-seat cover may be manufactured of a single unit or may be of multiple pieces, which combine together to achieve the desired dimension. Although it can vary in form, the dimensions of the fender-seat cover, primarily length and width, are such that in the first position, the fender-seat cover is capable of deflecting mud and water sprayed upward by the vehicle's rear tire and, in the second position, the fender-seat cover is capable of covering and protecting the seat of a parked vehicle from rainfall or other weather such as UV rays. The fender-seat cover can be attached to the arm(s) by bolting through built in tabs on the fender-seat cover or by riveting or otherwise attaching it to a separate mount piece, which can then be bolted, snapped, or clamped into place on the arm(s).

### BRIEF DESCRIPTION OF THE DRAWINGS

The accompanying drawings, which are incorporated herein and form a part of the specification, illustrate the present invention and, together with the description, further serve to explain the principles of the invention and to enable a person skilled in the pertinent art to make and use the invention.

FIG. 1 shows a side view of the fender cover position of one of the embodiments of the fender-seat cover device;

FIG. 2 shows a side view of the seat cover position of one of the embodiments of the fender-seat cover device;

FIG. 3 is a perspective view of the fender-seat cover to demonstrate the use of built-in tabs;

FIG. 4 is a perspective view of a clamp-style mount, which attaches to a vehicle's seat's seat rails;

FIG. 5 shows a side view of the fender position for a folding-style fender-seat cover device;

FIG. 6 shows a side view of the seat cover position for the folding-style fender-seat cover device;

FIG. 7 shows a side view of the fender cover position for the stretchable fender-seat cover device;

FIG. 8 shows a side view of the seat cover position for the stretchable fender-seat cover device; and

FIG. 9 demonstrates one possible use and position of the fender-seat cover storage container.

### DETAILED DESCRIPTION OF THE INVENTION

In the following detailed description of the invention of exemplary embodiments of the invention, reference is made to the accompanying drawings (where like numbers represent like elements), which form a part hereof, and in which is shown by way of illustration specific exemplary embodiments in which the invention may be practiced. These embodiments are described in sufficient detail to enable those skilled in the art to practice the invention, but other embodiments may be utilized and logical, mechanical, electrical, and other changes may be made without departing from the scope of the present invention. The following detailed description is, therefore, not to be taken in a limiting sense, and the scope of the present invention is defined only by the appended claims.

In the following description, numerous specific details are set forth to provide a thorough understanding of the invention. However, it is understood that the invention may be practiced without these specific details. In other instances, well-known structures and techniques known to one of ordinary skill in the art have not been shown in detail in order not to obscure the invention. Referring to the figures, it is possible to see the various major elements constituting the apparatus of the present invention.

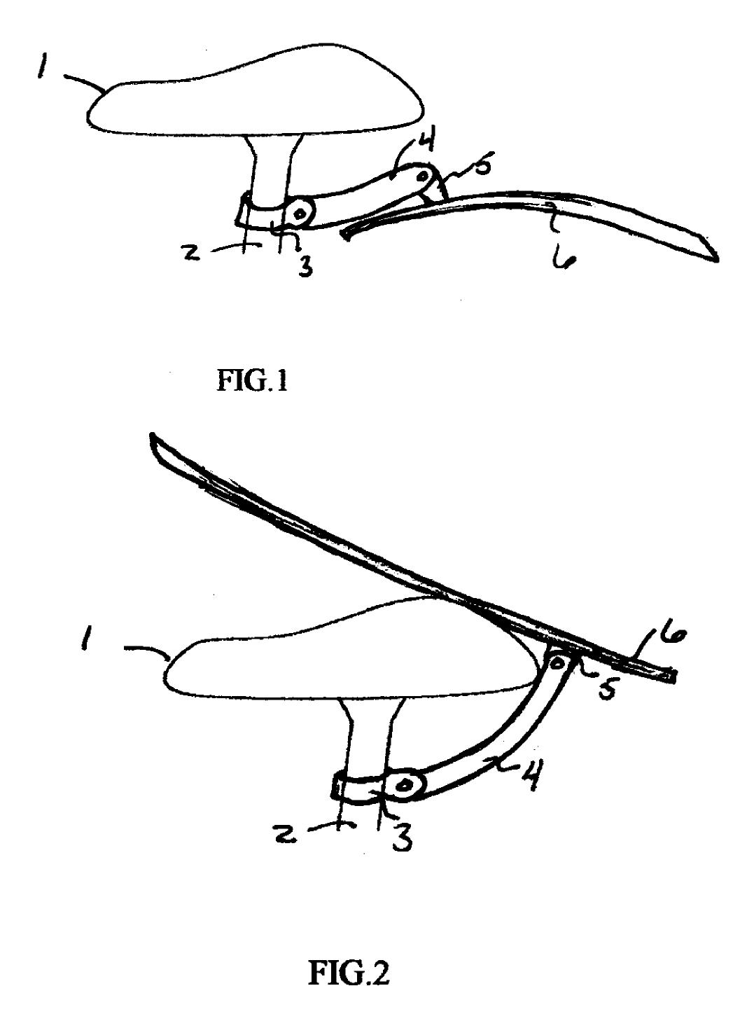

Now referring to the Figures, the embodiment of the invention is a combination fender-seat cover for a dual-wheeled vehicle such as a bicycle or motorcycle accessory as shown in FIGS. 1 and 2 composed principally of a mount device 3, a cantilevered arm 4, and a convertible fender-seat cover device. Upon its attachment to a vehicle, the combination fender seat and cover 6 is designed so that it has two primary operating positions: the seat cover position demonstrated in FIG. 2 and the fender position demonstrated in FIG. 1. The invention's purpose is to protect the vehicle's driver and seat from inclement weather conditions.

The combination fender-seat cover is, in its preferred embodiment, manufactured out of a durable plastic material. This plastic material could be any thermoplastic or thermoset material which can be formed, molded, or fabricated by conventional means, and may contain additives such as reinforcing agents, stabilizers, dyes, and other compound enhancers or fillers. The combination fender-seat cover or part therefrom can also be manufactured from any appropriate metal or fabric, although more likely at a less favorable weight or durability to the vehicle driver using it.

For the embodiment of the combination fender-seat cover shown in FIG. 1 and FIG. 2, the preferred method of position change from a first position to a second position or vice-versa is accomplished by a pivot or rotation, but can also be achieved by removal then reattachment. The fender-seat cover device 6 can have fixed or variable final and intermediate position options while converting from a first fender position show in FIG. 1 to a second seat covering position shown in FIG. 2. These position options can be achieved through various means such as pinning, snapping, bolting, and clamping into place. It is important to note that since the combination fender-seat cover is subject to shock and vibrations while the vehicle is in use, care must be taken to prevent bolts and other fasteners from coming loose.

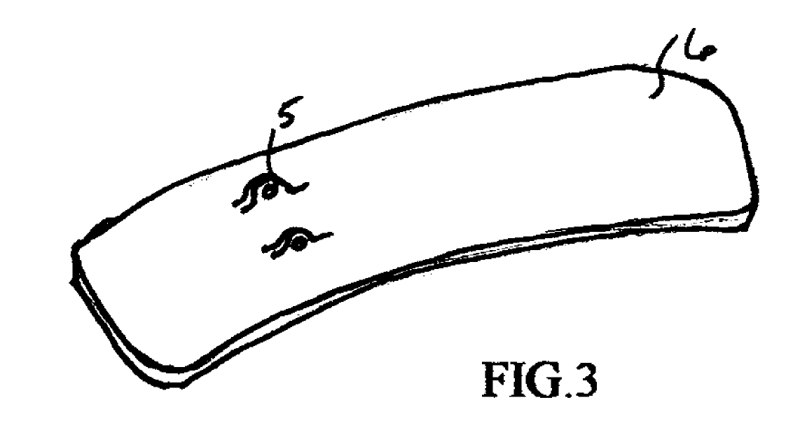

The fender-seat cover device 6 shown in FIG. 1 is curved; however it can be straight and it can have longitudinal ribs for additional structural support. The fender-seat cover device 6 may be manufactured of a single unit or may be of multiple pieces, which combine together to achieve the desired dimension. Although it can vary in form, the dimensions of the fender-seat cover device 6, primarily length and width, are such that in the first position shown in FIG. 1, the fender-seat cover device 6 is capable of deflecting mud and water sprayed upward by the rear vehicle tire and in the second position as shown in FIG. 2, the fender-seat cover device 6 is capable of covering and protecting the seat 1 of a parked vehicle from rainfall or other weather however is best to state it so that it also includes UV rays from the sun and snow etc. The fender-seat cover device 6 can be attached to the arm(s) 4 by bolting through built in tabs 5 on the fender-seat cover device 6 as shown in FIG. 3 or by riveting or otherwise attaching it to a separate mount piece, which can then be bolted, snapped, or clamped into place on the arm(s) 4.

The arm(s) 4 of the combination fender-seat cover 6 extend from the mount 3 to a location that allows the fender-seat cover 6 to be positioned over the vehicle seat 1 so as to accomplish its purpose of protecting the seat 1 from weather and rainfall; this extension may be adjacent to the rear of the seat 1 or may flank the seat 1 on either or both sides. The arm(s) 4 can be a single support or multiple, preferably two or four supports, extending from the mount as a single member or as multiple members such as in a four-bar linkage. The design of the arm(s) 4 may be of any type that achieves its previously described functional purpose; it may be solid, have weight-reducing slots, and may have an aerodynamically favorable shape. The arm(s) 4 can be a stationary extension from the mount 3 or it may pivot. If pivoting, the arm(s) 4 are thus attached to the mount 3 by bolting, riveting, snapping, or any method thereof.

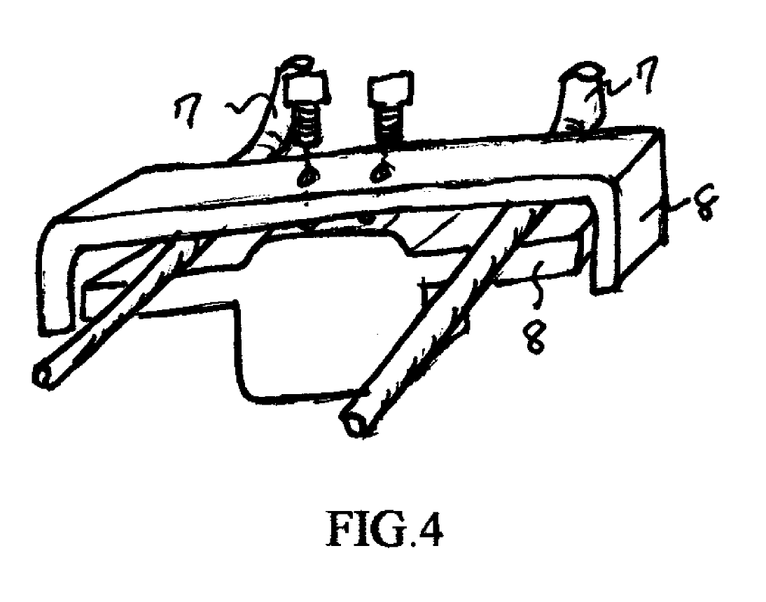

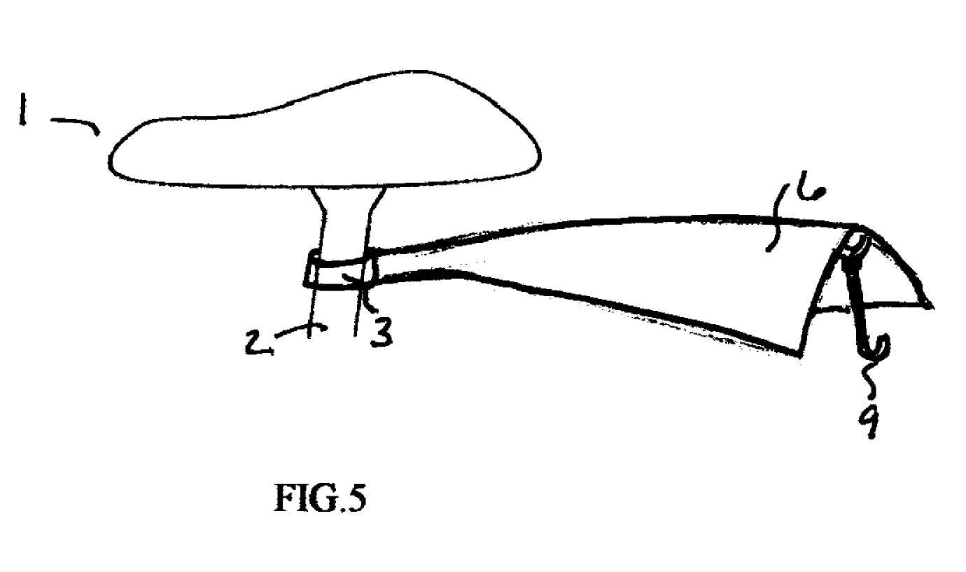

In one embodiment, the combination fender-seat cover mounts to the seat tube 2 as shown in FIG. 1 although the fender-seat cover may mount to the seat rails 7 or other existing vehicle hardware. Attachment to the vehicle can be achieved by strapping, clamping, or bolting in the desired position. The specific design of the mount 3 is dependant upon the attachment selection. For example, if the mount 3 is designed to be positioned on the seat rails 7, the mount 3 may be clamped 8 as shown in FIG. 4 or it may use VELCRO straps. In addition, the mount 3 may be manufactured in various sizes to allow for attachment to multiple style vehicles.

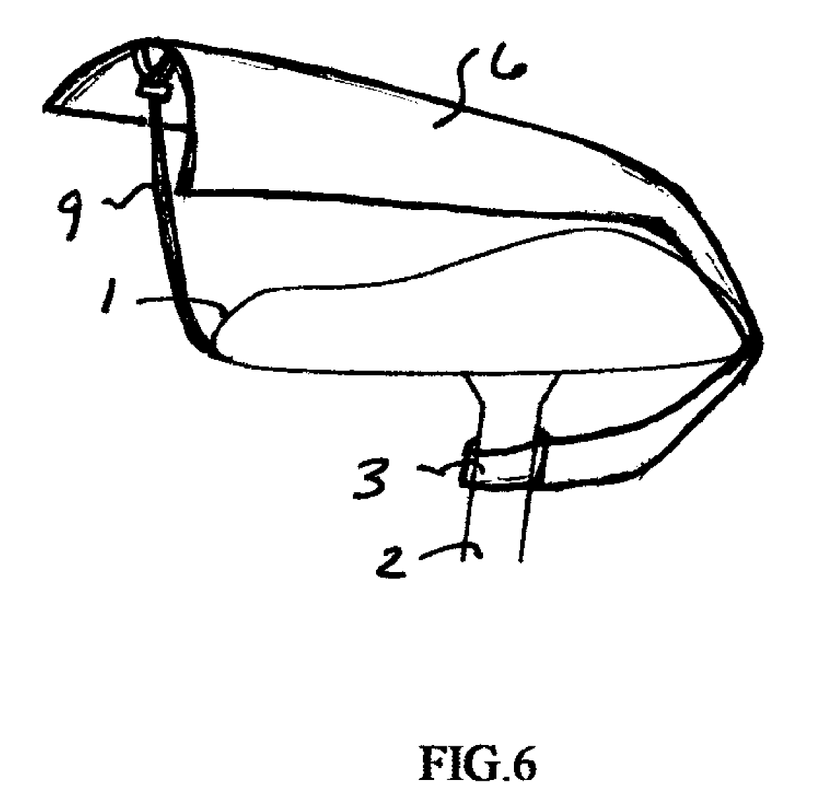

Another variation of the combination fender-seat cover is shown in FIG. 5 and FIG. 6. This embodiment consists of a flexible fender-seat cover device 6 which, by its material nature, can be folded back over the seat as shown in FIGS. 5 and 6; thus in this case, the fender-seat cover device 6 also serves the role of the arm. The material may have a memory which causes it to be concave in a first fender position as shown in FIG. 5 and it may flex to a convex shape in a second seat covering position as shown in FIG. 6, or the fender-seat cover device 6 may be flat in either position. Careful consideration must be taken to ensure the material is resilient enough so the fender-seat cover device 6 remains functional and does not develop fatigue failure soon after continuous use. To ensure the fender-seat cover device 6 does not fold back to a first fender position as shown in FIG. 5 from a second seat covering position as shown in FIG. 6 before desired, the fender-seat cover device 6 may be anchored to the seat by a flexible strap 9. The strap 9 may hook to the front of the seat 1 or it may anchor the fender-seat cover device 6 by another means. This embodiment of the combination fender-seat cover may employ an arm(s) 4 or it may not. It may be mounted to the vehicle in a cantilever position by any of the means described in previous embodiments such as clamping, strapping, etc.

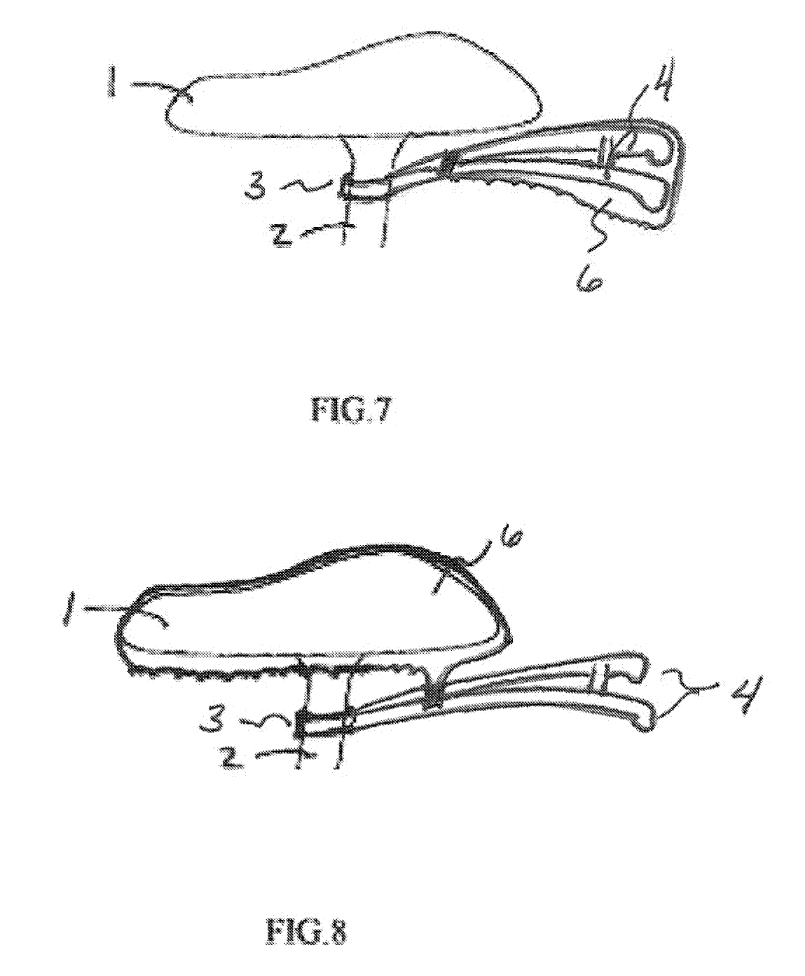

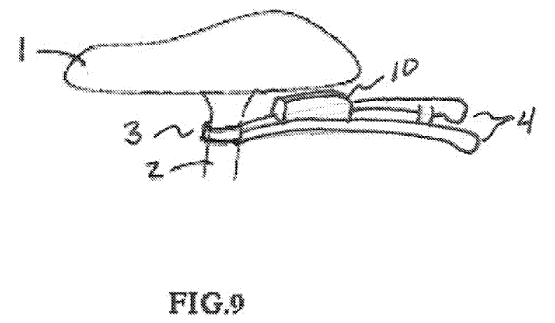

For the alternative embodiment of the fender-seat cover shown in FIG. 7 and FIG. 8, the fender-seat cover device 6 is fabricated from a more flexible plastic or waterproof textile which, while operating in the fender position shown in FIG. 7, the fender-seat cover device 6 is stretched over the cantilevered arm(s) 4. While in the seat cover position as shown in FIG. 7, the fender-seat cover device 6 is stretched over the seat 1 in a method similar to the use of a shower cap to protect the vehicle seat from weather and rainfall as shown in FIG. 8. Therefore, the fender-seat cover device 6 must be large enough to envelop most seats 1 and may, in its preferred embodiment, include a tightening method around the edge to ensure it does not get blown off the seat 1 or arm(s) 4 by wind. This tightening method may be elastic, a drawstring or anything of that sort. The fender-seat cover device 6 preferably remains anchored at the base of the arms 4 in both operating positions, but it may be detachable as previously stated. For example, the attachment method may be permanent such as one that is stitched or bonded by adhesive or welding processes, or it may be detachable such as one that is snapped. The detachable version has the befit of facilitating washing.

A storage container 10 in which to put the fender-seat cover device 6 when not in use is also a possible addition. An example is provided in FIG. 9 for the flexible embodiment of the fender-seat cover device 6. The storage container 10, may be made of any appropriate durable fabric or textile and may be waterproof or it may have mesh or other breathable material to help dry the fender-seat cover device 6 while in its stored position. The storage container 10 may only store the fender-seat cover device 6 or it may include additional storage compartments for items such as the cyclist's keys or tire-changing equipment. Whether or not additional storage is present, the storage container 10 must be of a large enough size to at least provide ample storage for the fender-seat cover device 6, but small enough so as not to be obtrusive to the driver of the vehicle. The storage compartment(s) may use a zipper, drawstring, or other appropriate closure techniques. The preferred closure technique for the fender-seat cover storage compartment is a drawstring or ratcheting device. These closure techniques allow a tight and secure closure but do not offer the possibility of the fender-seat cover device 6 getting stuck in and damaged by a zipper or the user hassle of attempting to line up and lock a tightly fitting snap. The storage container 10 may also have reflective materials or surfaces and may include a lighting system with a stored power supply to serve as additional safety equipment for the vehicle.

The storage container 10 shown in FIG. 9 is mounted beneath the back of the vehicle's seat 1 at the base of the arms 4; however, this is only one possible location for the storage container 10. It could be mounted under the front of the seat 1 or it could be mounted on the seat post 2 depending on whether the fender-seat cover device 6 is detachable or not. The storage container 10 may mount to the vehicle using a bracket similar to those used by most bicycle reflectors 14 or it may attach directly to the vehicle. In any configuration, removability of the storage container 10 is often preferred by drivers and thus attachment of the storage container 10 to the vehicle can be achieved using straps, clips, clamps, a bracket or other detachable arrangements.

All of the combination fender-seat cover embodiments may employ standard theft prevention techniques such as locking fasteners, cable loops for running a lock cable through, or other securement methods.

Thus, it is appreciated that the optimum dimensional relationships for the parts of the invention, to include variation in size, materials, shape, form, function, and manner of operation, assembly and use, are deemed readily apparent and obvious to one of ordinary skill in the art, and all equivalent relationships to those illustrated in the drawings and described in the above description are intended to be encompassed by the present invention.

Furthermore, other areas of art may benefit from this method and adjustments to the design are anticipated. Thus, the scope of the invention should be determined by the appended claims and their legal equivalents, rather than by the examples given.

The embodiments of the invention in which an exclusive property or privilege is claimed are defined as follows:

1. A combination fender-seat cover for a dual wheeled vehicle comprising:
a mounting device;
a convertible fender and seat cover device; and
the combination fender-seat cover has two primary operating positions,
the seat cover position, and
the fender position.

2. The combination fender-seat cover of claim 1 wherein a pivot or rotation having fixed or variable final and intermediate position options provides the means for position change from a fender position to a seat cover position or vice-versa.

3. The combination fender-seat cover of claim 1 wherein the mounting device attaches to a seat tube.

4. The combination fender-seat cover of claim 1 wherein the mounting device attaches to seat rails.

5. The combination fender-seat cover of claim 1 wherein attachment to the dual wheeled vehicle is achieved by strapping, clamping, or bolting the mounting device in the desired position.

6. The convertible fender and seat cover device of claim 1 wherein the convertible fender and seat cover device, by its material nature, provides the means for position change from a fender position to a seat cover position or vice-versa.

7. The convertible fender-seat cover device of claim 1 wherein the material of the convertible fender and seat cover device has a memory which causes it to be concave, convex or flat in a fender position while allowing the convertible fender and seat cover device to flex into a convex, concave or flat shape in a seat covering position.

8. The convertible fender-seat cover device of claim 8 wherein the convertible fender and seat cover device is anchored to the seat by a flexible strap, hook or other attachment means; whereby the combination fender-seat cover can be quickly converted from a fender position to a seat cover position.

9. A combination fender-seat cover for a dual wheeled vehicle comprising:
a mounting device;
one or more cantilevered arms;
a fender and seat cover device; and
the combination fender-seat cover has two primary operating positions,
the seat cover position, and
the fender position.

10. The fender and seat cover device of claim 9 being manufactured of a single unit or from a plurality of pieces, which combine together to achieve the desired dimension.

11. The combination fender-seat cover of claim 9 wherein attachment to the dual wheeled vehicle is achieved by strapping, clamping, or bolting the mounting device in the desired position.

12. The combination fender-seat cover of claim 9 wherein a pivot or rotation having fixed or variable final and intermediate position options provides the means for position change from a fender position to a seat cover position or vice-versa.

13. The combination fender-seat cover of claim 9 wherein a pivot, rotation, detachment or translation provides the means for position change from a fender position to a seat cover position or vice-versa.

14. The fender and seat cover device of claim 9 being curved.

15. The fender and seat cover device of claim 9 having longitudinal ribs for additional structural support.

16. The combination fender-seat cover of claim 9 wherein the fender and seat cover device is attached to one or more cantilevered arms by bolting through built in tabs on the fender and seat cover device or by riveting or otherwise attaching the fender and seat cover device to a separate mount piece which can then be bolted, snapped or clamped into place on the one or more cantilevered arms.

17. The combination fender-seat cover of claim 9 wherein
one or more cantilevered arms extend from the mounting device to a location that allows the fender and seat cover device to be positioned over a vehicle seat;
the one or more cantilevered arms are adjacent to the rear of the seat or flank the seat on one or more sides; and
the one or more arms can be stationary extensions from the mounting device or may pivot if attached to the mounting device by any means enabling movement.

18. The fender and seat cover device of claim 9 wherein the fender and seat cover device is fabricated from a flexible plastic or waterproof textile.

19. The fender and seat cover device of claim 18 wherein the fender and seat cover device is stretched, tightened, or otherwise secured over one or more cantilevered arms while operating in a fender position; and while operating in a seat cover position, the fender and seat cover device is stretched, tightened, or otherwise secured over the seat.

20. The combination fender-seat cover of claim 18 further comprising a storage container defining a storage compartment in which to store the fender and seat cover device when not in use, wherein the storage compartment is closeable to contain the fender and seat cover device therein and being openable to release the fender and seat cover device from the storage compartment to be deployed in a seat cover position or a fender position.

21. The combination fender-seat cover of claim 20 wherein the storage container is further comprised of additional storage compartments being closeable to contain items therein and being openable to allow the removal of items stored therein.

22. The combination fender-seat cover of claim 18 wherein the storage container is further comprised of reflective materials or surfaces and a lighting system with a stored power supply.
